(19) United States
(12) Patent Application Publication
(10) Pub. No.: US 2024/0297356 A1
(43) Pub. Date: Sep. 5, 2024

(54) RECYCLING METHOD OF LITHIUM IRON PHOSPHATE BATTERY

(71) Applicant: UWin Resource Regeneration Inc., New Taipei City (TW)

(72) Inventors: Ching-Hsiang HSU, New Taipei City (TW); Jia-Hao HU, New Taipei City (TW)

(73) Assignee: UWin Resource Regeneration Inc., New Taipei City (TW)

(21) Appl. No.: 18/211,798

(22) Filed: Jun. 20, 2023

(30) Foreign Application Priority Data
Mar. 3, 2023 (TW) 112107720

(51) Int. Cl. H01M 10/54; C22B 7/00; C22B 26/12

(52) U.S. Cl. CPC H01M 10/54; C22B 7/001; C22B 7/007; C22B 26/12

(57) ABSTRACT

The present application provides a recycling method of a lithium iron phosphate battery. The method comprises the following steps: i) providing a first powder comprising lithium iron phosphate battery waste; ii) removing copper and aluminum from the first powder to obtain a second powder, iii) dissolving the second powder obtained in step ii) in nitric acid to obtain a solution; iv) adding carbonic acid in the solution obtained in step iii) and separating a lithium carbonate precipitate; and v) removing a remaining solution of step iv) by vacuum distillation to obtain a ferric nitrate crystal.

### BACKGROUND OF THE INVENTION

### Field of the Invention

The present invention relates to a recycling method of a lithium iron phosphate battery and, in particular, to a method for recycling valuable metals such as copper, aluminum, lithium, and iron in a lithium iron phosphate battery waste.

### Description of the Prior Art

Lithium iron phosphate (LiFePO₄, also known as iron lithium phosphate, lithium iron phosphorus, abbreviated to LFP) is positive electrode/cathode material of lithium ion battery. Batteries that use lithium iron phosphate as the positive electrode material and carbon as the negative electrode material are called lithium iron phosphate batteries or lithium iron batteries. The characteristic of such battery is that it does not contain precious metals such as cobalt. Besides, phosphorus and iron are abundant in the earth, their price are low, and they have no shortage issue. The lithium iron phosphate battery has a working voltage of 3.3V, a battery capacity of 170 mAh/g, high discharge power, fast charging property, long cycle life, and high stability in high temperature.

Due to the advantages of low cost (no cobalt) and high safety of the lithium iron phosphate battery, it is widely used in the power battery of electric vehicles. As the usage increases, a lot of waste is naturally generated. In order to achieve the sustainable development goals (SDGs) and avoid mining raw ore from damaging the environment, the standards regard using recycled materials to battery products has begun regulated internationally. At present, the common recycling methods for lithium iron phosphate batteries waste include fire method and wet method. The fire method burns the waste at a high temperature of 1000 to 2000° C. to melt the waste into a metal alloy, and then separates and recycles different metal The fire method has an overall recycling rate of only 32-50% and the process is cumbersome and energy-consuming. In addition, a large amount of carbon dioxide or toxic gas will be generated during the process. The wet method is to disassemble the positive electrode material of the lithium iron phosphate battery, dissolve lithium ions and iron ions from electrode with solvents such as phosphoric acid, hydrochloric acid and hydrogen peroxide, and then recycle them by precipitation method. Although the wet method has a high recycling rate (<70%), it need extra step to disassemble batteries waste. The extra step requires additional manpower and is quite time-consuming. Further, a large amount of solvents such as phosphoric acid, hydrochloric acid, and hydrogen peroxide will be used in wet method. During the dissolution process, a large amount of toxic and irritating gas will be produced, which is not environmentally friendly.

Therefore, it is necessary to provide a recycling method of lithium iron phosphate battery that is easy to operate, safe, environmentally friendly and has a high recycling rate.

### SUMMARY OF THE INVENTION

According to an embodiment of the present invention, a recycling method of a lithium iron phosphate battery is provided. The recycling method comprises the following steps: i) providing a powder comprising lithium iron phosphate battery waste; ii) removing copper and aluminum from the powder; iii) dissolving the powder of step ii) in a nitric acid to obtain a solution; iv) adding carbonic acid in the solution of step iii) and separating a lithium carbonate precipitate; and v) removing the remaining solution of step iv) by vacuum distillation to obtain a ferric nitrate crystal.

In an embodiment, the copper is removed from the powder of step ii) by gravity separation in Step ii).

In an embodiment, the aluminum is removed from the powder of step ii) by Sortinger Magnetic Separator and the aluminum is removed after the copper removal in Step ii).

In an embodiment, a concentration of the nitric acid added in step iii) is between 1 M and 10 M, a liquid-solid ratio (mL:g) of the nitric acid to the second powder is between 1:1 and 5:1, and a dissolution temperature is between 15° C. and 90° C. in step iii).

In an embodiment, an extraction rate of lithium and iron in the powder of step iii) is more than 99 wt %.

In an embodiment, the recycling method further comprises a step iv-1): reducing the lithium carbonate precipitate to lithium metal.

In an embodiment, step iv) is carried out at a temperature between 50° C. and 80° C.

In an embodiment, a lithium recycling rate of step iv) is equal to or more than 94 wt %.

In an embodiment, the recycling method further comprises a step v-1): reducing the ferric nitrate crystal to iron metal.

In an embodiment, the vacuum distillation of step v) is carried out at a vacuum degree of −700 to −750 torr and a temperature of 50° C. to 90° C.

In an embodiment, an iron recycling rate of step v) is equal to or more than 99 wt %.

In an embodiment, a distillate obtained in step v) is a nitric acid aqueous solution.

In an embodiment, the powder of step i) is obtained through discharging, crushing and/or pulverizing the lithium iron phosphate battery waste.

In order to make the above-mentioned and other aspects of the present invention clearer and easier to understand, the following specific embodiments are described in detail in conjunction with the accompanying drawings.

### BRIEF DESCRIPTION OF THE DRAWINGS

FIG. 1 is a flowchart illustrating a recycling method of a lithium iron phosphate battery according to an embodiment of the present invention.

### DETAILED DESCRIPTION OF THE EMBODIMENTS

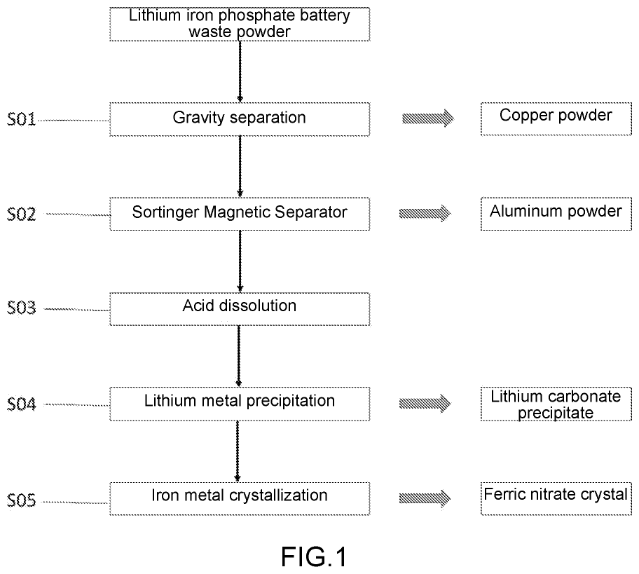

Please refer to FIG. 1, which illustrates a flowchart of a lithium iron phosphate battery recycling method according to an embodiment of the present invention. The lithium iron phosphate battery recycling method of the present invention may comprise five steps including gravity separation S01, Sortinger Magnetic Separator S02, acid dissolution S03, lithium metal precipitation S04 and iron metal crystallization S05. After the lithium iron phosphate battery waste is treated by the recycling method of the present invention, the valuable metals contained therein, including copper, aluminum, lithium, iron and the like, can be effectively recovered/recycled. The examples are described in detail below.

### Lithium Iron Phosphate Battery Waste

The lithium iron phosphate battery waste of the present embodiment is powdery, and the source of the powder is a private recycling site. The private recycling site will collect lithium iron phosphate batteries waste, and after preliminary screening and discharging processes, the batteries waste will be transformed into powder by physical destruction methods, such as crushing, pulverization and mincing (in some embodiment, the screening process is after the physical destruction process). There may be omissions in the screening process, and the recycling site generally does not disassemble the battery carefully, so the collected waste powder may contain impurities such as electrolyte, negative electrode material, or other types of batteries.

In order to facilitate the follow-up calculation of the recycling rate of each metal, the composition analysis for the metal to be recovered/recycled (valuable metal) in the powder is done first. The analysis method is well-known aqua regia digestion method. This method treats the sample to be analyzed (i.e. waste powder) with aqua regia (a 3:1 mixture of hydrochloric acid and nitric acid), and the sample solution is heated and decomposition in a microwave digestion furnace. The measurand elements (valuable metal) were measured in the solutions of digested samples using inductively coupled plasma mass spectrometer (ICP-MS) . . . . Other composition analysis methods can also be used, as long as the content of the metal to be recovered/recycled in the powder can be quantified. The valuable metal content of the lithium iron phosphate battery waste powder of the present embodiment is presented in the below Table 1:

TABLE 1
Valuable metal content of lithium
iron phosphate battery waste powder

| Metal | Li | Fe | Cu | Al |
|---|---|---|---|---|
| Content | 1.52% | 16.30% | 8.17% | 6.75% |
| (wt %) | | | | |

As can be seen from Table 1, the content of the valuable metals: lithium, iron, copper, and aluminum only accounts for about 32.7% in the lithium iron phosphate battery waste powder of the present embodiment. The rest of the waste powder are impurities.

### Copper Removal

Next, as shown in step S01, the copper in the lithium iron phosphate battery waste powder is removed by gravity separation.

The density of lithium iron phosphate (LiFePO₄) is 1.5 g/cm³, the density of aluminum is 2.7 g/cm³, and the density of copper is 8.9 g/cm³. The density of these three metals is very different, so the copper with the highest density can be effectively removed by gravity separation, and the remaining solid powder contains lithium iron phosphate and aluminum.

The gravity separation method used in this example is a vibration separation method. The powder is placed on a table with an inclination angle of 3 to 5 degrees, the separation is performed at a vibration frequency of 18 to 22 Hz, and the powder after copper removal can be obtained. The aqua regia digestion method is used again to measure the copper content in the remaining powder, and then the copper recycling rate can be calculated. The calculation formula of copper recycling rate is:

$$[ 1 - ( \frac{copper content of powder after copper removal}{copper content of lithium iron phosphate battery waste powder} ) \times 100 \% .$$

The operating parameters and the copper recycling rate of the gravity separation of the present embodiment are present in the below Table 2:

TABLE 2
Result of copper removal by gravity separation

| | Operating parameters (inclination | | |
|---|---|---|---|
| | angle, vibration frequency) | | |
| | 3 degrees, | 4 degrees, | 5 degrees, |
| | 22 Hz | 20 Hz | 18 Hz |
| Copper recycling | 99.82% | 99.37% | 99.24% |
| rate (%) | | | |

As can be seen from Table 2, the gravity separation method can effectively remove the copper with the highest density, and the recycling rate is higher than 99%. However, the present invention does not limit the copper removal method. In addition to the gravity separation method used in this embodiment, as long as the copper in the lithium iron phosphate battery waste powder can be effectively removed, other copper removal methods can also be used.

### Aluminum Removal

Next, as shown in step S02, the aluminum in the lithium iron phosphate battery waste powder is removed by Sortinger Magnetic Separator.

The conductivity of lithium iron phosphate is very low (about 10⁻⁹ S/cm), but aluminum is a good conductor (conductivity is about 37.8×10⁴ S/cm). Since the conductive substance can move in the magnetic field, aluminum can be effectively removed in the magnetic field, and the remaining solid powder is lithium iron phosphate.

In this example, the powder after the copper removal in step S01 is put into the Sortinger Magnetic Separator, the conveying speed and revolution of the belt are controlled to 20-100 m/min and under 2000 rpm respectively. Then, adjusting the turbine output to remove aluminum from waste powder. The aluminum content in the remaining powder is measured by aqua regia digestion method again, and then the recycling rate of aluminum is calculated. The calculation formula of aluminum recycling rate is:

$$[ 1 - ( \frac{aluminum content of powder after copper removal}{aluminum content of lithium iron phosphate battery waste powder} ) \times 100 \% .$$

The operating parameters and the aluminum recycling rate of the Sortinger Magnetic Separator of the present embodiment are presented in the below Table 3:

TABLE 3
Result of aluminum removal by Sortinger Magnetic Separator

Belt speed (m/min)

| | 20 | 20 | 100 | 100 |
|---|---|---|---|---|
| Turbine | 2.2 | 3.7 | 2.2 | 3.7 |
| output (kW) | | | | |
| Aluminum | 97.58% | 98.63% | 99.21% | 99.93% |
| recycling rate (%) | | | | |

As can be seen from Table 3, the Sortinger Magnetic Separator can effectively remove aluminum with high conductivity, and the recycling rate is higher than 97%. However, the present invention does not limit the method of removing aluminum. In addition to the Sortinger Magnetic Separator method used in this embodiment, as long as the aluminum in the lithium iron phosphate battery waste powder can be effectively removed, other aluminum removal methods can also be used.

Since copper is also a metal with high electrical conductivity, in this embodiment, copper needs to be removed before removal of aluminum by Sortinger Magnetic Separator.

### Acid Dissolution

Next, as shown in step S03, the lithium iron phosphate battery waste powder (copper and aluminum are removed) are dissolved in nitric acid.

Using impregnation methods with different operating conditions, lithium iron phosphate can be effectively dissolved in nitric acid to obtain an extract. The operating conditions of acid dissolution are shown in the below Table 4, wherein the calculation formula of lithium/iron extraction rate is:

$$\frac{lithium / iron content in nitric acid extraction solution}{lithium / iron content of lithium iron phosphate battery waste power} \times 100 \% .$$

TABLE 4
Operating conditions and results of acid dissolution
of lithium iron phosphate battery

| | | | | | | | Condition | |
|---|---|---|---|---|---|---|---|---|
| | Condition | | Condition | | Condition | | D | |
| | A | | B | | C | | (the best) | |
| Nitric acid | 1M | | 5M | | 10M | | 5M | |
| concentration | | | | | | | | |
| Liquid-solid | 1:1-5:1 | | 1:1-5:1 | | 1:1-5:1 | | 3:1 | |
| ratio (mL:g) | | | | | | | | |
| Temperature | 70-90° | C. | 40-60° | C. | 15-25° | C. | 50° | C. |
| Soaking time | 0.5-2 | hr | 1-4 | hr | 6-12 | hr | 1 | hr |

| | | | | |
|---|---|---|---|---|
| Lithium | >99.6% | >99.8% | >99.3% | 99.93% |
| extraction | | | | |
| rate (%) | | | | |
| Iron extraction | >99.5% | >99.8% | >99.3% | 99.91% |
| rate (%) | | | | |

As can be seen from Table 4, lithium iron phosphate is easily to dissolve in nitric acid in different temperature ranges from 15 to 90° C., in different concentration ranges from 1 to 10M, and in different liquid-solid ratios (mL:g) from 1:1 to 5:1, and the extraction rate is high (>99%). For example, condition C reveals that even at room temperature, a high extraction rate of lithium and iron can still be obtained, but it takes a long time. Condition D achieves a better balance between heating temperature and extraction time, and can also obtain a high extraction rate of lithium and iron.

### Lithium Recycling

Next, as shown in step S04, adding carbonic acid to the extract of the acid dissolution step S03. Carbonic acid will react with lithium ions to form a solid lithium carbonate precipitate, and ferric ions will remain in the liquid phase extract. The reaction formula of lithium carbonate precipitate is as follows:

2Li⁺+Fe³⁺+2NO₃⁻+H₂CO₃→Li₂CO₃↓+Fe³⁺+2HNO₃

The results of precipitation reaction are shown in Table 5. The calculation formula of lithium recycling rate is:

$$[ 1 - ( \frac{lithium content of the extract after lithium carbonate precipitation}{lithium content of lithium iron phosphate battery waste powder} ) ] \times 100 \%$$

TABLE 5
Results of lithium recycling by precipitation reaction

| | Temperature | | |
|---|---|---|---|
| | 20° C. | 50° C. | 80° C. |
| Lithium recycling | 91.24% | 94.82% | 99.39% |
| rate (%) | | | |

As shown in Table 5, the higher the temperature of the precipitation reaction, the more the reaction balance is towards the right side, and a higher lithium recycling rate can be obtained. Preferably, the temperature of the precipitation reaction in step S04 is between 50° C. and 80° C., and the lithium recycling rate is equal to or greater than 94%.

The extract of step S04 can be filtered to get the lithium carbonate precipitate. The lithium metal in the lithium carbonate can be recycled by reduction reaction.

### Iron Recycling

Finally, as shown in step S05, the remaining liquid phase extract of step S04 is distilled under reduced pressure, and the solvent is removed to obtain ferric nitrate Fe(NO₃)₃ crystals to recycle iron metal. The solvent in the extract can be removed by vacuum distillation, and excess nitrate ions can be distilled into nitric acid aqueous solution (distillate), which can be reused. The remaining solid crystals are ferric nitrate. Refer to Table 6 for operating parameters and results of iron recycling by vacuum distillation. The formula for calculating the iron recycling rate is:

$$[ 1 - ( \frac{Iron content of distillate}{Iron content of lithium iron phosphate battery waste powder} ) ] \times 100 \%$$

TABLE 6
Results of iron recycling by vacuum distillation

| | Vacuum degree | | |
|---|---|---|---|
| | −700 Torr | −725 Torr | −750 Torr |
| Temperature | 90° C. | 70° C. | 50° C. |
| Iron recycling | 98.73% | 99.04% | 99.59% |
| rate (%) | | | |

Vacuum degree refers to the difference between actual air pressure and 1 atmosphere (760 torr). As shown in Table 6, the lower the vacuum degree (lower actual air pressure), the lower the required heating temperature. On the contrary, the higher the vacuum degree, the closer the air pressure is to 1 atmosphere, and a higher heating temperature is required. Preferably, the vacuum degree of the vacuum distillation step is between −700 to −750 torr, and the heating temperature is between 50 to 90° C.

The ferric nitrate crystal obtained in step S05 can be further subject to reduction reaction to obtain iron metal, so as to achieve the purpose of recycling.

The lithium iron phosphate battery recycling method according to the embodiment of the present invention combines two recycling methods of dry/wet methods. The dry method is as shown in step S01 (gravity separation) and S02 (Sortinger Magnetic Separator) of FIG. 1, which remove copper and aluminum physically. The wet method is as shown in step S03 of FIG. 1 to immerse the lithium iron phosphate battery waste in an acidic solution, and then dissolve the lithium iron phosphate. Table 7 shows the comparison between the acid dissolution step of the present invention and the traditional recycling method.

TABLE 7
The comparison between the recycling method
according to the embodiment of the present
invention and the traditional wet method

| | The present | | Traditional wet | | Traditional wet | |
|---|---|---|---|---|---|---|
| | invention | | method 1 | | method 2 | |
| Solvent of acid | nitric acid | | phosphoric acid | | hydrochloric acid | |
| dissolution | | | & hydrogen | | and hydrogen | |
| | | | peroxide | | peroxide | |
| Extraction rate | >99% | | 60-80% | | 70-90% | |
| Extraction | 1-4 | hr | 8-12 | hr | 6-8 | hr |
| speed | | | | | | |
| Reaction | 20-50° | C. | 70-90° | C. | 70-80° | C. |
| temperature | | | | | | |
| Saturation | >100 | g/L | 20-50 | g/L | 30-65 | g/L |

| | | | |
|---|---|---|---|
| Wastewater | Recyclable | high phosphorous | high halogen |
| | | waste liquid | waste liquid |
| Reaction | Moderate, | Vigorous, | Vigorous, |
| condition | normal | irritating | toxic |
| | temperature | gas | chlorine gas |

As shown in table 7, compared with the traditional wet method, the acid dissolution step S03 of the present invention can be carried out at a lower temperature due to the earlier removal of impurities such as copper and aluminum. Besides, the step has shorter recycling time, higher extraction rate, and generate no waste water and stimulating/toxic gas, which is more friendly to environment.

The lithium iron phosphate battery recycling method according to the embodiment of the present invention can effectively recover lithium iron phosphate battery waste. There is no need to disassemble the positive electrode of battery, so the process is more feasible for mass production. This method has a high recycling rate for valuable metals: copper, aluminum, lithium, and iron, with an average recycling rate of above 94%. The recycling rate is better than the traditional wet method. In addition, this recycling method uses physical methods to remove copper and aluminum first, which can greatly reduce the amount of acid using in the impregnation method. The method is a relatively non-toxic, low energy consumption, and low carbon emission recycling method, which meets the current environmental protection requirements and carbon reduction trends. What's more, the nitric acid using in the impregnation method can be recycled in the subsequent vacuum distillation process, thereby reducing waste water and achieving sustainable production.

Although the present invention has been disclosed above with embodiments, which are not intended to limit the present invention. Those of ordinary skill in the art, after referring to the above teachings, should be able to make appropriate modifications to the content of the above embodiments, and still achieve the effects claimed in this application. Therefore, the protection scope of the present invention should be determined according to the appended claims.

1. A recycling method of a lithium iron phosphate battery, comprising:
i) providing a powder comprising lithium iron phosphate battery waste;
ii) removing copper and aluminum from the powder;
iii) dissolving the powder of step ii) in a nitric acid to obtain a solution;
iv) adding carbonic acid in the solution of step iii) and separating a lithium carbonate precipitate; and
v) removing the remaining solution of step iv) by vacuum distillation to obtain a ferric nitrate crystal.

2. The recycling method of claim 1, wherein the copper is removed from the powder of step ii) by gravity separation in Step ii).

3. The recycling method of claim 1, wherein the aluminum is removed from the powder of step ii) by Sortinger Magnetic Separator and the aluminum is removed after the copper removal in Step ii).

4. The recycling method of claim 1, wherein in step iii), a concentration of the nitric acid is between 1 M and 10 M, a liquid-solid ratio (mL:g) of the nitric acid to the second powder is between 1:1 and 5:1, and a dissolution temperature is between 15° C. and 90° C. in step iii).

5. The recycling method of claim 4, wherein an extraction rate of lithium and iron in the powder of step iii) is more than 99 wt %.

6. The recycling method of claim 1, further comprising a step iv-1): reducing the lithium carbonate precipitate to lithium metal.

7. The recycling method of claim 1, wherein step iv) is carried out at a temperature between 50° C. and 80° C.

8. The recycling method of claim 7, wherein a lithium recycling rate of step iv) is equal to or more than 94 wt %.

9. The recycling method of claim 1, further comprising a step v-1): reducing the ferric nitrate crystal to iron metal.

10. The recycling method of claim 1, wherein the vacuum distillation of step v) is carried out at a vacuum degree of −700 to −750 torr and a temperature of 50° C. to 90° C.

11. The recycling method of claim 10, wherein an iron recycling rate of step v) is equal to or more than 99 wt %.

12. The recycling method of claim 1, wherein a distillate obtained in step v) is a nitric acid aqueous solution.

13. The recycling method of claim 1, wherein the powder of step i) is obtained through discharging, crushing and/or pulverizing the lithium iron phosphate battery waste.

14. The recycling method of claim 2, wherein the aluminum is removed from the powder of step ii) by Sortinger Magnetic Separator and the aluminum is removed after the copper removal in Step ii).
